(19) United States
(12) Patent Application Publication
(10) Pub. No.: US 2024/0190429 A1
(43) Pub. Date: Jun. 13, 2024

(54) VEHICLE CONTROL APPARATUS

(71) Applicant: TOYOTA JIDOSHA KABUSHIKI KAISHA, Toyota-shi (JP)

(72) Inventor: Shin NOMURA, Seto-shi (JP)

(73) Assignee: TOYOTA JIDOSHA KABUSHIKI KAISHA, Toyota-shi (JP)

(21) Appl. No.: 18/530,922

(22) Filed: Dec. 6, 2023

(30) Foreign Application Priority Data
Dec. 9, 2022 (JP) 2022-196971

(51) Int. Cl. B60W 30/14; B60W 40/105; B60W 50/14; G01S 19/42

(52) U.S. Cl. CPC B60W 30/143; B60W 40/105; B60W 50/14; G01S 19/42; B60W 2050/0022

(57) ABSTRACT

A vehicle control apparatus having a meter display ECU and a vehicle speed control ECU. The meter display ECU acquires the GNSS speed of the host vehicle, calculates the gain error of the detected vehicle speed, and calculates a meter display speed based on the detected vehicle speed, the gain error, and the offset value. The meter display ECU calculates an offset value ensure that the meter display speed equals or exceeds both the detected vehicle speed and the GNSS speed, based on past gain error calculations. The vehicle speed control ECU calculates the meter display speed using the gain error and offset value acquired from the meter display ECU and the detected vehicle speed acquired from the vehicle speed sensor.

### CROSS-REFERENCE TO RELATED APPLICATIONS

This application is based upon and claims the benefit of priority from Japanese Patent Application No. 2022-196971, filed on Dec. 9, 2022, the entire contents of which are incorporated herein by reference.

### TECHNICAL FIELD

The present disclosure relates to a vehicle control apparatus.

### BACKGROUND

Japanese Patent No. 6400450 has been known as a technical document related to a vehicle control apparatus. In this publication, a GPS speed calculated based on a positioning signal of a positioning satellite is used. Then, the vehicle speed detected by a vehicle speed sensor of the vehicle is corrected using the GPS speed.

### SUMMARY

By the way, it is stipulated by law that the meter display speed displayed on the speedometer of the host vehicle, should display a value equal to or greater than the actual vehicle speed. In a case where the vehicle speed is corrected using the GPS speed as in the related art described above, there is a possibility that the regulation cannot be complied with depending on the situation only by displaying the corrected vehicle speed as the meter display speed.

A vehicle control apparatus according to an aspect of the present disclosure, including a meter display ECU that calculates a meter display speed displayed on a speedometer of a host vehicle and a vehicle speed control ECU that performs vehicle speed control of the host vehicle. The meter display ECU includes a GNSS speed acquisition unit that acquires a GNSS speed of a host vehicle from a GNSS reception unit of the host vehicle. The meter display ECU further includes a gain error calculation unit that calculates a gain error of the detected vehicle speed based on the detected vehicle speed of the vehicle speed sensor of the host vehicle and the GNSS speed. The meter display ECU further includes a meter display speed calculation unit that calculates a meter display speed based on the detected vehicle speed, the gain error, and the offset value, and an offset value calculation unit that calculates an offset value ensure that the meter display speed equals or exceeds both the detected vehicle speed and the GNSS speed, based on past gain error calculations. The vehicle speed control ECU includes a display speed calculation unit for calculating a meter display speed using a gain error and an offset value acquired from the meter display ECU and a detected vehicle speed acquired from a vehicle speed sensor, and a vehicle speed control unit for manage the host vehicle's acceleration or deceleration, ensuring that the meter display speed matches a preset target vehicle speed.

In the vehicle control apparatus, the meter display ECU may set the maximum value of the gain error calculated during the previous driving as the initial value of the gain error calculated by the gain error calculation unit, when the host vehicle ignition ON. The meter display ECU may set the maximum value of the offset value calculated in the previous driving as the initial value of the offset value calculated by the offset value calculation unit.

According to the vehicle control apparatus, the offset value is calculated such that the meter display speed is a value equal to or greater than the detected vehicle speed and the GNSS speed, and thus it is possible to satisfy a requirement of a regulation related to display of a speedometer. According to the vehicle control apparatus, a communication load between ECUs can be reduced by transmitting a gain error and an offset value from the meter display ECU to the vehicle speed control ECU and calculating a meter display speed on the vehicle speed control ECU side.

### BRIEF DESCRIPTION OF THE DRAWINGS

FIG. 1 is a block diagram illustrating a vehicle control apparatus according to an exemplary embodiment.

FIG. 2 is a graph for explaining the detected vehicle speed, the GNSS speed, the gain error correction vehicle speed, and the meter display speed.

FIG. 3 is a flowchart illustrating an example of the meter display speed calculation processing by the meter display ECU.

FIG. 4 is a flowchart illustrating an example of a vehicle speed control process by the vehicle speed control ECU.

### DETAILED DESCRIPTION

Hereinafter, embodiments of the present disclosure will be described with reference to the drawings.

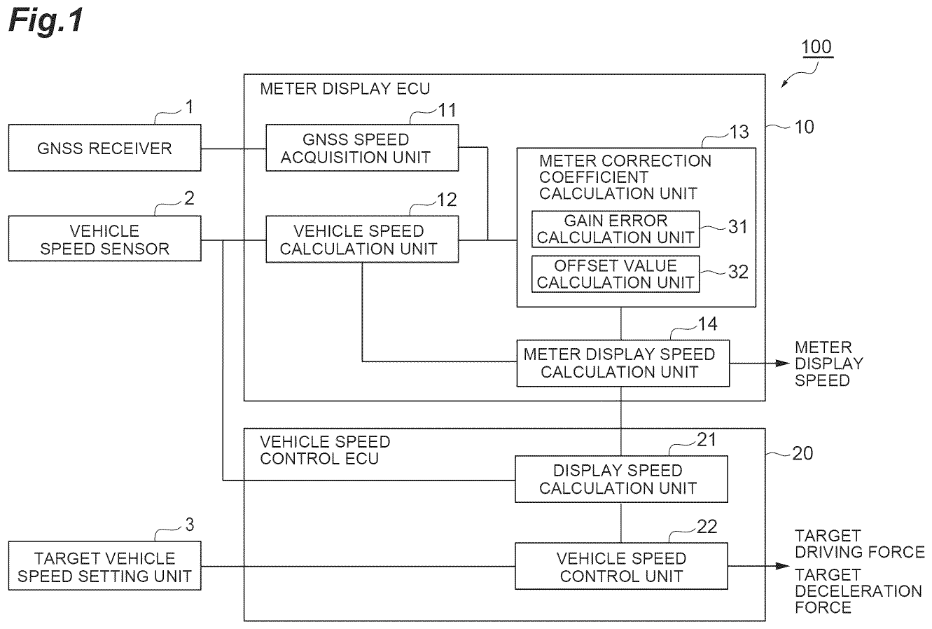

A vehicle control apparatus 100 illustrated in FIG. 1 is mounted on a host vehicle. The vehicle control apparatus 100 is a device that calculates the meter display speed of the host vehicle and controls the vehicle speed. The vehicle control apparatus 100 includes a meter display ECU 10 that calculates meter display speed and a vehicle speed control ECU 20 that performs vehicle speed control.

First, the meter display ECU 10 will be described. The meter display ECU 10 is an electronic control unit including a CPU and a storage unit such as a ROM or a RAM. In the meter display ECU 10, for example, various functions are realized by executing a program stored in the storage unit by the CPU. The meter display ECU 10 may be composed of a plurality of electronic units. The configuration of the vehicle speed control ECU 20 may be similar.

As illustrated in FIG. 1, the meter display ECU 10 is connected to a GNSS (Global Navigation Satellite System) receiver 1 and a vehicle speed sensor 2. The GNSS receiver 1 measures the position of the host vehicle (for example, the latitude and longitude of the host vehicle) by receiving a carrier wave (GNSS signal) from positioning satellites. The GNSS receiver 1 transmits the acquired frequency-information of the carrier wave to the meter display ECU 10. Note that the GNSS receiver 1 includes a global positioning system (GPS) receiver. It may be a receiving unit.

The vehicle speed sensor 2 is a detector that detects the vehicle speed of the host vehicle. As the vehicle speed sensor, for example, a wheel speed sensor that is provided on a wheel of a host vehicle or a drive shaft that rotates integrally with the wheel and detects the rotation speed of the wheel is used. The vehicle speed sensor transmits detected vehicle speed information (for example, a vehicle speed pulse signal of the wheel speed sensor) to the meter display ECU 10. The vehicle speed sensor also transmits the detected vehicle speed information to the vehicle speed control ECU 20.

Next, the functional configuration of the meter display ECU 10 will be described. The meter display ECU 10 has a GNSS speed acquisition unit 11, a vehicle speed calculation unit 12, a meter correction coefficient calculation unit 13, and a meter display speed calculation unit 14.

The GNSS speed acquisition unit 11 acquires the GNSS speed of the host vehicle based on the carrier wave of the positioning satellite (GNSS satellite) received by the GNSS reception unit 1. The GNSS speed is the speed of the host vehicle calculated from the carrier wave of the positioning satellite. The GNSS speed acquisition unit 11 calculates a GNSS speed based on the frequency change of the carrier wave emitted by positioning satellites. The frequency change may be due to the Doppler effect. The GNSS speed acquisition unit 11 can calculate a GNSS speed by using carrier waves of four or more positioning satellites, for example.

The vehicle speed calculation unit 12 calculates the detected vehicle speed of the host vehicle based on the detected vehicle speed information of the vehicle speed sensor 2. In the vehicle speed calculation unit 12, a detected vehicle speed is obtained from a vehicle speed pulse signal, for example.

The meter correction coefficient calculation unit 13 calculates a meter correction coefficient for calculating meter display speed. The meter correction coefficient includes a gain error and an offset value. As illustrated in FIG. 1, the meter correction coefficient calculation unit 13 has a gain error calculation unit 31 and an offset value calculation unit 32.

The gain error calculation unit 31 calculates a gain error of the detected vehicle speed based on the detected vehicle speed of the host vehicle and the GNSS speed. Gain error is a coefficient used for calculation of meter display speed. An error occurs in the detected vehicle speed due to a change in tire diameter or distortion of a drive shaft caused by running of a host vehicle. Therefore, the gain error for correcting the detected vehicle speed is calculated using the GNSS speed having high accuracy.

An example of the gain error can be obtained from an equation of GNSS speed=gain error×detected vehicle speed. The gain error in this case is a value obtained by dividing the GNSS speed by the detected vehicle speed. The gain error may be obtained by applying a least square method to the detected vehicle speed and the GNSS speed at a certain time. The gain error calculation unit 31 may calculate a gain error for correcting the detected vehicle speed so as to approach the GNSS speed by a Kalman filter or other processing instead of the least square method.

The offset value calculation unit 32 calculates the offset value based on the past gain error calculations. Offset value is a coefficient used for calculation of meter display speed. The calculation of offset value will be described in detail later.

The meter display speed calculation unit 14 calculates meter display speed based on the detected vehicle speed, gain error, and offset value. To be specific, the meter display speed calculation unit 14 calculates meter display speed by adding offset value to gain error correction vehicle speed obtained by multiplying the detected vehicle speed by gain error. That is, the meter display speed calculation unit 14 can obtain the meter display speed as meter display speed=gain error×detected vehicle speed+offset value.

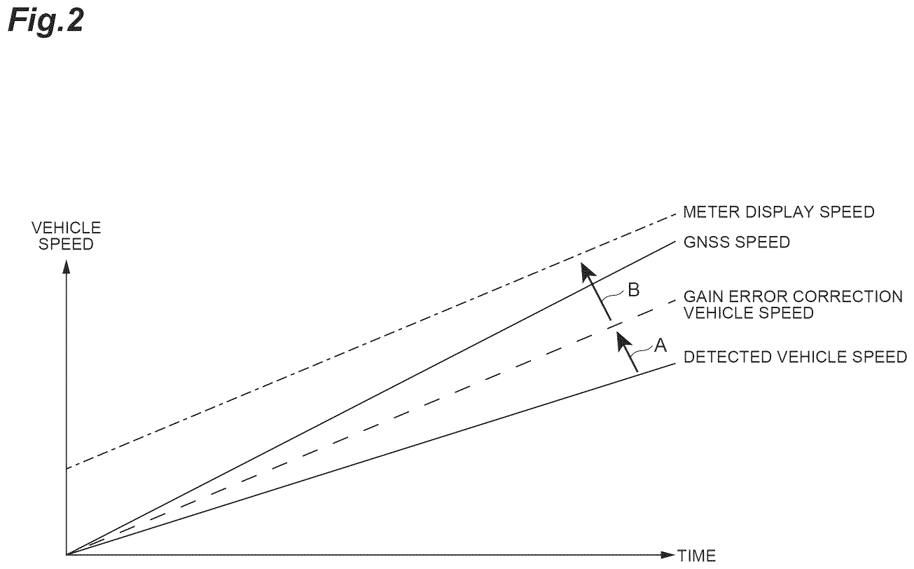

Here, FIG. 2 is a graph for describing the detected vehicle speed, the GNSS speed, the gain error correction vehicle speed, and the meter display speed. In the graph of FIG. 2, the vertical axis represents vehicle speed, and the horizontal axis represents time. FIG. 2 shows the detected vehicle speed, the GNSS speed, the gain error correction vehicle speed, and the meter display speed. In FIG. 2, a situation where the detected vehicle speed is lower than the GNSS speed is shown as an example. In the situation illustrated in FIG. 2, the gain error correction vehicle speed is obtained by multiplying the detected vehicle speed by the gain error as illustrated in an arrow A. The gain error corrected vehicle speed is a vehicle speed corrected so as to approach the GNSS speed from the detected vehicle speed.

In FIG. 2, the gain error correction vehicle speed is lower than the GNSS speed. If the gain error correction vehicle speed is directly set to meter display speed, there is a possibility that the requirements of the laws and regulations regarding display of speedometer are not satisfied. The requirement of the law relating to the display of the speedometer is a requirement for requiring that the meter display speed displayed on the speedometer of the host vehicle is a value equal to or greater than the actual vehicle speed. Therefore, the meter display speed calculation unit 14 calculates the meter display speed as a value equal to or greater than the detected vehicle speed and the GNSS speed by adding the offset value to the gain error correction vehicle speed as indicated by an arrow B.

The offset value is set so as to satisfy the requirement of a regulation related to display of a speedometer. The offset value calculation unit 32 calculates the offset value to ensure that the meter display speed equals or exceeds both the detected vehicle speed and the GNSS speed, based on past gain error calculations. The offset value calculation unit 32 calculates the offset value ensure that the meter display speed equals or exceeds both the detected vehicle speed and the GNSS speed even when the gain error is minimized. The offset value calculation unit 32 may be obtained as a value obtained by adding a fixed value to a difference between a larger value of the detected vehicle speed or the GNSS speed and the gain error correction vehicle speed in a case where the gain error is minimized.

By adding the offset value calculated as described above to the gain error correction vehicle speed, the meter display speed calculation unit 14 can obtain a meter display speed that is equal to or higher than the detected vehicle speed and the GNSS speed. The meter display speed calculation unit 14 outputs meter display speed to other parts. The meter display speed calculation unit 14 outputs a signal corresponding to the meter display speed to the speedometer of the host vehicle, for example. The meter display speed calculation unit 14 transmits the gain error and offset value used to calculate meter display speed to the vehicle speed control ECU 20.

When the host vehicle is in ignition ON state, the meter display ECU 10 may be set such that the maximum value of the gain error calculated in the previous driving is set as the initial value of the gain error calculated by the gain error calculation unit 31. Similarly, at the time of the ignition ON of the host vehicle, the meter display ECU 10 may set the maximum value of the offset value calculated at the time of previous traveling as the initial value of the offset value calculated by the offset value calculation unit 32.

The meter display ECU 10 may calculate so that gain error and offset value do not exceed the initial values. In addition, the initial value of offset value may be determined in advance by assuming that a tire having a maximum diameter that can be mounted on the host vehicle is mounted. In this way, the meter display ECU 10 is able to meet the requirements of the speedometer regulations even if tires of different diameters are changed between ignition OFF.

Next, the vehicle speed control ECU 20 will be described. As illustrated in FIG. 1, the vehicle speed control ECU 20 is connected to the vehicle speed sensor 2 and a target vehicle speed setting unit 3.

The target vehicle speed setting unit 3 sets a target vehicle speed used for the vehicle speed control. The target vehicle speed setting unit 3 sets a target vehicle speed of cruise control as driving support based on, for example, an operation of the user. The target vehicle speed setting unit 3 may set a target vehicle speed of speed management which is deceleration support before a curve based on an operation of the user. The target vehicle speed setting unit 3 may set the target vehicle speed of other driving support based on the operation of the user. The target vehicle speed setting unit 3 may set a target vehicle speed as autonomous driving control. In this case, the target vehicle speed setting unit 3 may constitute a part of the travel plan generation function in the autonomous driving control.

The vehicle speed control ECU 20 has a display speed calculation unit 21 and a vehicle speed control unit 22. The display speed calculation unit 21 calculates the meter display speed based on the gain error and offset value transmitted from the meter display ECU 10 and the detected vehicle speed acquired from the vehicle speed sensor 2. The calculation method of meter display speed is the same as that of the meter display ECU 10.

The vehicle speed control unit 22 manages the host vehicle's acceleration or deceleration, ensuring that the meter display speed matches a preset target vehicle speed. The vehicle speed control unit 22 executes vehicle speed control by accelerating or decelerating the host vehicle so that the meter display speed calculated by the display speed calculation unit 21 becomes the target vehicle speed set by the target vehicle speed setting unit 3. The vehicle speed control may be driving assistance such as cruise control or may be a part of autonomous driving control. The vehicle speed control unit 22 calculates, for example, a target driving force or a target deceleration force for the meter display speed to become the target vehicle speed.

The vehicle speed control unit 22 accelerates the host vehicle by transmitting a signal corresponding to the target driving force to the drive actuator of the host vehicle. The drive actuator is, for example, a throttle actuator. The drive actuator may be a motor in a hybrid electric vehicle or a battery electric vehicle. The vehicle speed control unit 22 decelerates the host vehicle by transmitting a signal corresponding to the target deceleration force to the brake actuator of the host vehicle. The vehicle speed control unit 22 may control acceleration or deceleration of the host vehicle by other known approaches.

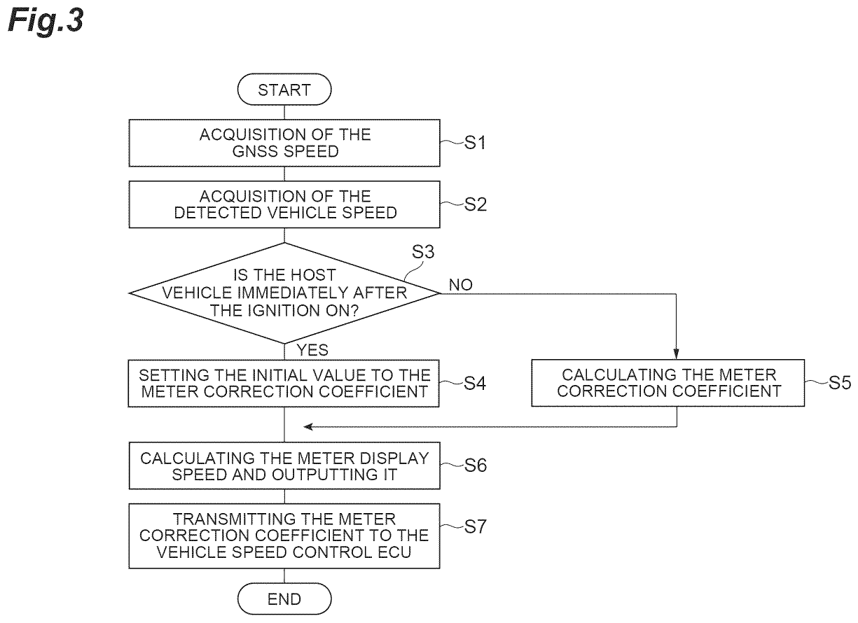

Next, the vehicle control apparatus 100 processing according to the present embodiment will be described with reference to the drawings. FIG. 3 is a flowchart illustrating an example of the meter display speed calculation processing by the meter display ECU. The meter display speed calculation process is executed while the ignition of the host vehicle is ON, for example.

As illustrated in FIG. 3, the meter display ECU 10 of the vehicle control apparatus 100 acquires the GNSS speed of the host vehicle by the GNSS speed acquisition unit 11 as S1. The GNSS speed acquisition unit 11 acquires a GNSS speed based on the carrier wave of the positioning satellite received by the GNSS reception unit 1.

In S2, the meter display ECU 10 calculates the detected vehicle speed of the host vehicle by the vehicle speed calculation unit 12. The vehicle speed calculation unit 12 calculates the detected vehicle speed of the host vehicle based on the detected vehicle speed information of the vehicle speed sensor 2.

In S3, the meter display ECU 10 determines whether the host vehicle is immediately after the ignition ON. If the meter display ECU 10 determines that the host vehicle is immediately after the ignition ON, the process transitions to S4. If the meter display ECU 10 determines that the host vehicle is not immediately after the ignition ON, the process transitions to S5.

In S4, the meter display ECU 10 sets an initial value to the meter correction coefficient by the meter correction coefficient calculation unit 13. The meter correction coefficient calculation unit 13 sets, for example, the maximum value of the gain error calculated during the previous travel as the initial value of the gain error for calculating the gain error calculation unit 31. Similarly, the meter correction coefficient calculation unit 13 sets the maximum value of the offset value calculated in the previous travel as the initial value of the offset value for calculating the offset value calculation unit 32. The meter display ECU 10 then transfers to S6.

In S5, the meter display ECU 10 calculates a meter correction coefficient by the meter correction coefficient calculation unit 13. The gain error calculation unit 31 of the meter correction coefficient calculation unit 13 calculates a gain error of the detected vehicle speed based on the detected vehicle speed of the host vehicle and the GNSS speed. In the offset value calculation unit 32 of the meter correction coefficient calculation unit 13, the offset value is calculated such that the meter display speed becomes a value equal to or greater than the detected vehicle speed and the GNSS speed based on the past gain error calculations. The meter display ECU 10 then transfers to S6.

In the S6, the meter display ECU 10 calculates and outputs the meter display speed by the meter display speed calculation unit 14. The meter display speed calculation unit 14 calculates meter display speed by adding offset value to gain error correction vehicle speed obtained by multiplying the detected vehicle speed by gain error. The meter display speed calculation unit 14 outputs a signal corresponding to the meter display speed to the speedometer of the host vehicle, for example.

In S7, the meter display ECU 10 transmits a meter correction coefficient to the vehicle speed control ECU 20 by the meter display ECU 10. After that, the meter display ECU 10 ends the current meter display speed calculation processing. The meter display ECU 10 repeats the treatment from the S1 again after a period of time.

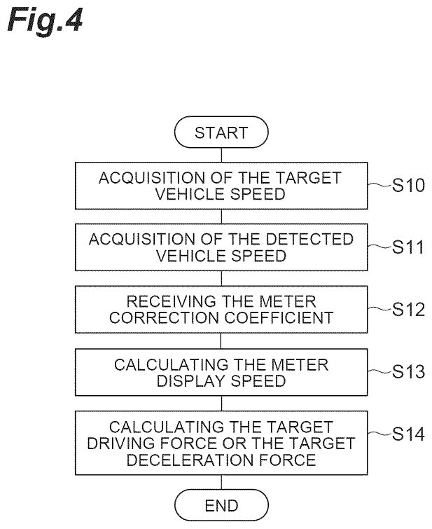

FIG. 4 is a flowchart illustrating an example of a vehicle speed control process by the vehicle speed control ECU 20. As illustrated in FIG. 4, the vehicle speed control ECU 20 acquires the target vehicle speed from the target vehicle speed setting unit 3 as S10. The target vehicle speed setting unit 3 sets a target vehicle speed of cruise control as driving support based on, for example, an operation of the user.

In S11, the vehicle speed control ECU 20 acquires the detected vehicle speed of the host vehicle from the display speed calculation unit 21. The display speed calculation unit 21 acquires the detected vehicle speed of the host vehicle from the vehicle speed sensor 2.

In S12, the vehicle speed control ECU 20 receives the meter correction coefficient from the meter display ECU 10. The display speed calculation unit 21 recognizes the gain error and offset value received from the meter display ECU 10.

In S13, the vehicle speed control ECU 20 calculates the meter display speed by the display speed calculation unit 21. The display speed calculation unit 21 calculates the meter display speed based on the gain error and offset value transmitted from the meter display ECU 10 and the detected vehicle speed acquired from the vehicle speed sensor 2.

In S14, the vehicle speed control ECU 20 calculates the target driving force or the target deceleration force for achieving a target vehicle speed by the vehicle speed control unit 22. The vehicle speed control unit 22 calculates, for example, a target driving force or a target deceleration force for the meter display speed to become the target vehicle speed.

According to the vehicle control apparatus 100 of the present embodiment described above, highly accurate speed information can be obtained by correcting the detected vehicle speed using the GNSS speed. In addition, according to the vehicle control apparatus 100, the offset value is calculated such that the meter display speed is equal to or greater than the detected vehicle speed and the GNSS speed, and thus it is possible to satisfy a requirement of a regulation related to display of a speedometer. Furthermore, according to the vehicle control apparatus 100, a communication load between ECUs can be reduced by transmitting a gain error and an offset value from the meter display ECU 10 to the vehicle speed control ECU 20 and calculating a meter display speed on the vehicle speed control ECU 20 side.

Although embodiments of the present disclosure have been described above, the present disclosure is not limited to the above-described embodiments. The present disclosure can be implemented in various forms in which various changes and modifications are made based on the knowledge of those skilled in the art, including the above-described embodiments.

For example, the GNSS speed acquisition unit 11 does not necessarily need to acquire the GNSS speed by the Doppler effect, and may obtain the position of the host vehicle from the carrier wave of the positioning satellite received by the GNSS reception unit 1 and calculate the GNSS speed from a change in the position of the host vehicle per unit time.

The initial values of the gain error and the offset value are not limited to the maximum values in the previous traveling. The initial value may be a fixed value or a value set by the user.

What is claimed is:

1. A vehicle control apparatus comprising:
a meter display ECU configured to calculate a meter display speed displayed on a speed meter of a host vehicle; and
a vehicle speed control ECU configured to perform vehicle speed control of the host vehicle;
wherein the meter display ECU comprising:
a GNSS speed acquisition unit configured to acquire a GNSS speed of the host vehicle from a GNSS receiver of the host vehicle;
a gain error calculation unit configured to calculate a gain error of the detected vehicle speed based on the GNSS speed and the detected vehicle speed from a vehicle speed sensor of the host vehicle; and
a meter display speed calculation unit configured to calculate meter display speed based on the detected vehicle speed, the gain error, and an offset value; and
an offset value calculation unit configured to calculate the offset value to ensure that the meter display speed equals or exceeds both the detected vehicle speed and the GNSS speed, based on past gain error calculations; and
wherein the vehicle speed control ECU comprising:
a display speed calculation unit configured to calculate the meter display speed using the gain error and the offset value acquired from the meter display ECU and the detected vehicle speed acquired from the vehicle speed sensor; and
a vehicle speed control unit configured to manage the host vehicle's acceleration or deceleration, ensuring that the meter display speed matches a preset target vehicle speed.

2. The vehicle control apparatus according to claim 1,
wherein, during an ignition ON of the host vehicle, the meter display ECU sets a maximum value of the gain error calculated during previous driving as an initial value of the gain error calculated by the gain error calculation unit, and sets a maximum value of the offset value calculated during previous driving as an initial value of the offset value calculated by the offset value calculation unit.

3. The vehicle control apparatus according to claim 1,
wherein the GNSS speed acquisition unit determines the GNSS speed based on frequency change of the carrier wave emitted by positioning satellites.

4. The vehicle control apparatus according to claim 2,
wherein the GNSS speed acquisition unit determines the GNSS speed based on frequency change of the carrier wave emitted by positioning satellites.
